(19) United States
(12) Patent Application Publication
(10) Pub. No.: US 2012/0103436 A1
(43) Pub. Date: May 3, 2012

(54) Two-handle Type Faucet Having a double Anti-reverse function to prevent waste materials from flowing backward into the faucet when disaster happens

(76) Inventor: JUI-FENG KO, LUGANG CHEN (TW)

(21) Appl. No.: 12/916,935

(22) Filed: Nov. 1, 2010

(51) Int. Cl. F16K 21/04

(52) U.S. Cl. 137/511

(57) ABSTRACT

A faucet includes a faucet body, a control valve mounted in the faucet body and a check valve mounted in the faucet body. The faucet body is provided with a first inlet, a second inlet, an upper outlet and a lower outlet. The control valve includes a valve body, a valve shaft, a sealing gasket and a stopper. The check valve includes a valve housing, a base, a plug and an elastic member. Thus, the plug is inserted into the socket of the valve housing to isolate the check valve from the lower outlet of the faucet body, while the sealing gasket presses the peripheral wall of the flow channel to isolate the flow channel from the check valve so that the faucet has a double anti-reverse function to prevent the waste water from flowing backward into the faucet.

### BACKGROUND OF THE INVENTION

1. Field of the Invention

The present invention relates to a faucet and, more particularly, to a two-handle type faucet.

2. Description of the Related Art

A conventional faucet comprises a faucet body having an inner portion provided with a receiving chamber and a control valve mounted in the receiving chamber of the faucet body. The faucet body is provided with a first inlet, a second inlet, an upper outlet and a lower outlet. The receiving chamber of the faucet body is connected between the first inlet, the second inlet, the upper outlet and the lower outlet of the faucet body. One of the first inlet and the second inlet of the faucet body is connected to a first control handle to supply cold water into the receiving chamber of the faucet body, and the other one of the first inlet and the second inlet of the faucet body is connected to a second control handle to supply hot water into the receiving chamber of the faucet body. The upper outlet of the faucet body is connected to a spout. The lower outlet of the faucet body is connected to a water outlet head. The water outlet head includes a press button, a hose and a connector. The connector of the water outlet head is connected with the lower outlet of the faucet body. In operation, when water is delivered through the first inlet and/or the second inlet of the faucet body into the receiving chamber of the faucet body, the water can be delivered into the spout or the water outlet head by operation of the control valve so that the water can be sprayed outward from the spout or the water outlet head for use with a user. However, when the water outlet head is placed in a drainage or sink, the waste water from the drainage or sink easily flows through the water outlet head and the lower outlet of the faucet body into the receiving chamber of the faucet body to pollute the water source of the first inlet and the second inlet of the faucet body, thereby causing danger to the user.

### BRIEF SUMMARY OF THE INVENTION

In accordance with the present invention, there is provided a faucet, comprising a faucet body having an inner portion provided with a receiving chamber, a control valve mounted in the receiving chamber of the faucet body and a check valve mounted in the receiving chamber of the faucet body and connected with the control valve. The faucet body is provided with a first inlet, a second inlet, an upper outlet and a lower outlet.

The control valve includes a valve body mounted in the receiving chamber of the faucet body and having an inner portion provided with a flow channel which has a peripheral wall provided with a flange, a valve shaft movably mounted in the flow channel of the valve body, a sealing gasket mounted on the valve shaft to move in concert with the valve shaft and abutting the peripheral wall of the flow channel to seal the flow channel of the valve body, and a stopper mounted on the valve shaft to move in concert with the valve shaft and detachably abutting the flange of the valve body to seal the flow channel of the valve body. The valve body of the control valve has a surface provided with two first connecting holes each connected between the flow channel of the valve body and the upper outlet of the faucet body and two second connecting holes each connected between the flow channel of the valve body and a respective one of the first inlet and the second inlet of the faucet body.

The check valve includes a valve housing mounted in the receiving chamber of the faucet body and having inner portion provided with a flow conduit which is connected to the flow channel of the valve body through the sealing gasket of the control valve and has a peripheral wall provided with a socket, a base mounted on the valve housing and connected between the valve housing and the lower outlet of the faucet body, a plug movably mounted in the flow conduit of the valve housing and detachably inserted into the socket of the valve housing to interrupt a connection between the flow conduit of the valve housing and the flow channel of the valve body, and an elastic member biased between the base and the plug to push the plug toward the socket of the valve housing.

The primary objective of the present invention is to provide a two-handle type faucet having a double anti-reverse function to prevent waste materials from flowing backward into the faucet when disaster happens.

According to the primary advantage of the present invention, the plug of the check valve is tightly inserted into the socket of the valve housing to isolate the check valve from the lower outlet of the faucet body, while the tapered thin wall of the sealing gasket presses the peripheral wall of the flow channel to isolate the flow channel of the valve body from the check valve so that the faucet has a double anti-reverse function to prevent the waste water from flowing backward into the faucet so as to protect the water source of the faucet.

According to another advantage of the present invention, the water can flow transversely through the openings of the valve housing so as to increase the water flow rate and to decrease the cost of fabrication.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a faucet in accordance with the preferred embodiment of the present invention.

FIG. 2 is a front cross-sectional assembly view of the faucet as shown in FIG. 1.

FIG. 3 is a schematic operational view of the faucet as shown in FIG. 2 in use.

FIG. 4 is a schematic operational view of the faucet as shown in FIG. 2 in use.

### DETAILED DESCRIPTION OF THE INVENTION

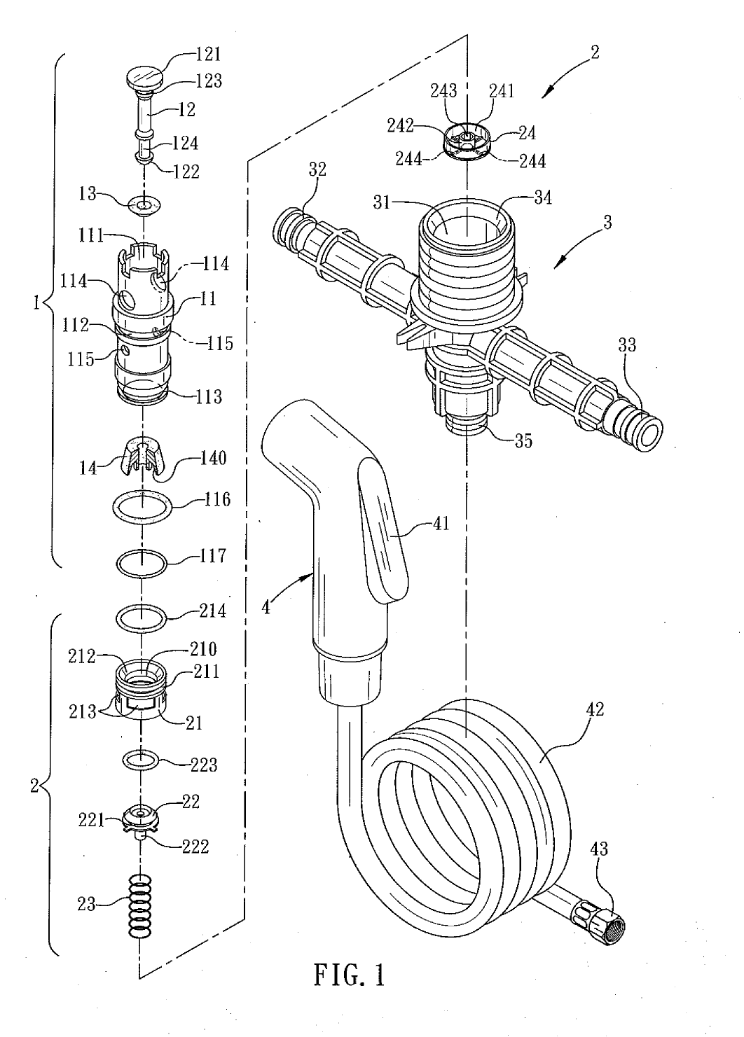

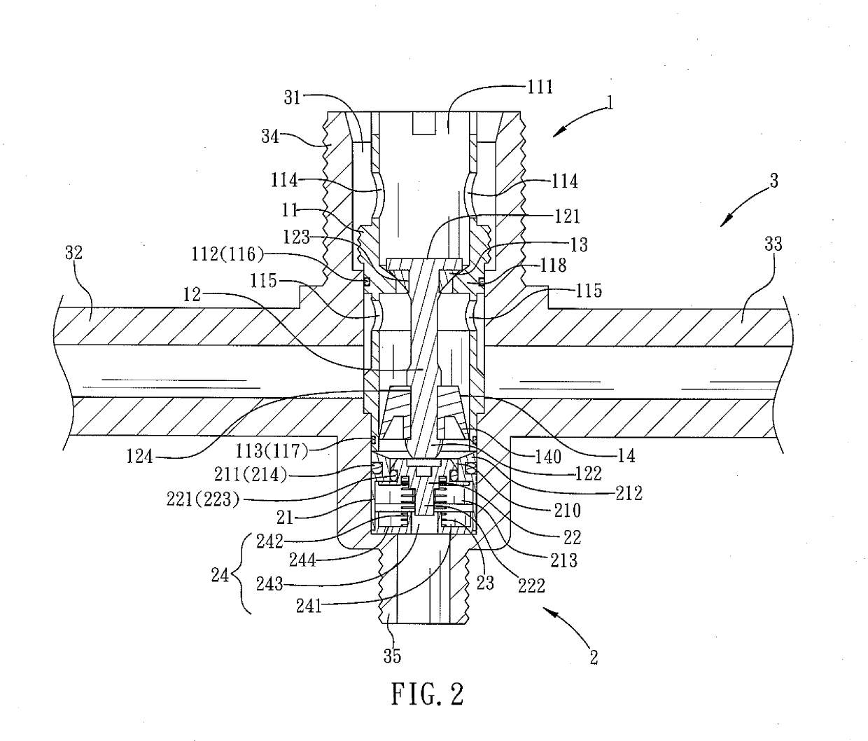

Referring to the drawings and initially to FIGS. 1 and 2, a faucet in accordance with the preferred embodiment of the present invention comprises a faucet body 3 having an inner portion provided with a receiving chamber 31, a control valve 1 mounted in the receiving chamber 31 of the faucet body 3 and a check valve 2 mounted in the receiving chamber 31 of the faucet body 3 and connected with the control valve 1.

The faucet body 3 is provided with a first inlet 32, a second inlet 33, an upper outlet 34 and a lower outlet 35. The first inlet 32, the second inlet 33, the upper outlet 34 and the lower outlet 35 of the faucet body 3 are isolated from each other, and each of the first inlet 32, the second inlet 33, the upper outlet 34 and the lower outlet 35 of the faucet body 3 is connected to the receiving chamber 31 of the faucet body 3. The receiving chamber 31 of the faucet body 3 is connected between the first inlet 32, the second inlet 33, the upper outlet 34 and the lower outlet 35 of the faucet body 3. One of the first inlet 32 and the second inlet 33 of the faucet body 3 is connected to a first control handle (not shown) to supply cold water into the receiving chamber 31 of the faucet body 3, and the other one of the first inlet 32 and the second inlet 33 of the faucet body 3 is connected to a second control handle (not shown) to supply hot water into the receiving chamber 31 of the faucet body 3. The upper outlet 34 of the faucet body 3 is connected to a spout (not shown). The lower outlet 35 of the faucet body 3 is connected to a water outlet head 4. The water outlet head 4 includes a press button 41, a hose 42 and a connector 43. The connector 43 of the water outlet head 4 is connected with the lower outlet 35 of the faucet body 3.

The control valve 1 is located between the upper outlet 34 of the faucet body 3 and the check valve 2 and includes a valve body 11 mounted in the receiving chamber 31 of the faucet body 3 and having an inner portion provided with a flow channel 111 which has a peripheral wall provided with a flange 118, a valve shaft 12 movably mounted in the flow channel 111 of the valve body 11, a sealing gasket 14 mounted on the valve shaft 12 to move in concert with the valve shaft 12 and abutting the peripheral wall of the flow channel 111 to seal the flow channel 111 of the valve body 11, and a stopper 13 mounted on the valve shaft 12 to move in concert with the valve shaft 12 and detachably abutting the flange 118 of the valve body 11 to seal the flow channel 111 of the valve body 11.

The valve body 11 of the control valve 1 has a surface provided with two first connecting holes 114 each connected between the flow channel 111 of the valve body 11 and the upper outlet 34 of the faucet body 3 and two second connecting holes 115 each connected between the flow channel 111 of the valve body 11 and a respective one of the first inlet 32 and the second inlet 33 of the faucet body 3. The flange 118 of the valve body 11 has a tapered shape and is located between the two first connecting holes 114 and the two second connecting holes 115. The valve body 11 of the control valve 1 has a peripheral wall provided with two retaining grooves 112 and 113 to receive two O-rings 116 and 117 which press a peripheral wall of the receiving chamber 31.

The valve shaft 12 of the control valve 1 has an enlarged upper end 121 provided with a first mounting portion 123 for mounting the stopper 13 and has an enlarged lower end 122 provided with a second mounting portion 124 for mounting the sealing gasket 14.

The stopper 13 of the control valve 1 has a tapered shape and is located between the flange 118 and the two first connecting holes 114 of the valve body 11.

The sealing gasket 14 of the control valve 1 is located between the two second connecting holes 115 of the valve body 11 and the check valve 2. The sealing gasket 14 of the control valve 1 has a substantially inverted V-shaped cross-sectional profile and has a tapered thin wall 140 pressing the peripheral wall of the flow channel 111 to isolate the flow channel 111 of the valve body 11 from the check valve 2. The tapered thin wall 140 of the sealing gasket 14 is flexible and contractible radially and inwardly to detach from the peripheral wall of the flow channel 111 to connect the flow channel 111 of the valve body 11 to the check valve 2.

The check valve 2 is located between the control valve 1 and the lower outlet 35 of the faucet body 3 and includes a valve housing 21 mounted in the receiving chamber 31 of the faucet body 3 and having inner portion provided with a flow conduit 210 which is connected to the flow channel 111 of the valve body 11 through the sealing gasket 14 of the control valve 1 and has a peripheral wall provided with a socket 212, a base 24 mounted on the valve housing 21 and connected between the valve housing 21 and the lower outlet 35 of the faucet body 3, a plug 22 movably mounted in the flow conduit 210 of the valve housing 21 and detachably inserted into the socket 212 of the valve housing 21 to interrupt a connection between the flow conduit 210 of the valve housing 21 and the flow channel 111 of the valve body 11, and an elastic member 23 biased between the base 24 and the plug 22 to push the plug 22 toward the socket 212 of the valve housing 21.

The valve housing 21 of the check valve 2 has an upper end juxtaposed to a lower end of the valve body 11 and a lower end mounted on the base 24. The valve housing 21 of the check valve 2 has a surface provided with a plurality of openings 213 each connected to the flow conduit 210. The valve housing 21 of the check valve 2 has a peripheral wall provided with a retaining groove 211 to receive an O-ring 214 which presses the peripheral wall of the receiving chamber 31.

The base 24 of the check valve 2 has an inner portion provided with a flow duct 241 connected between the flow conduit 210 of the valve housing 21 and the lower outlet 35 of the faucet body 3. The base 24 of the check valve 2 is provided with a mounting tube 242 located in the flow duct 241. The mounting tube 242 of the base 24 has an inner portion provided with a mounting hole 243. The base 24 of the check valve 2 has a bottom provided with a plurality of support ribs 244 connected with the mounting tube 242 to support the mounting tube 242.

The plug 22 of the check valve 2 is limited between the socket 212 of the valve housing 21 and the base 24 and has a lower end provided with guide rod 222 movably mounted in the mounting hole 243 of the mounting tube 242. The plug 22 of the check valve 2 has a peripheral wall provided with a retaining groove 221 to receive an O-ring 223 which presses a peripheral wall of the socket 212.

The elastic member 23 of the check valve 2 has an upper end mounted on the guide rod 222 of the plug 22 and a lower end mounted on the mounting tube 242 of the base 24.

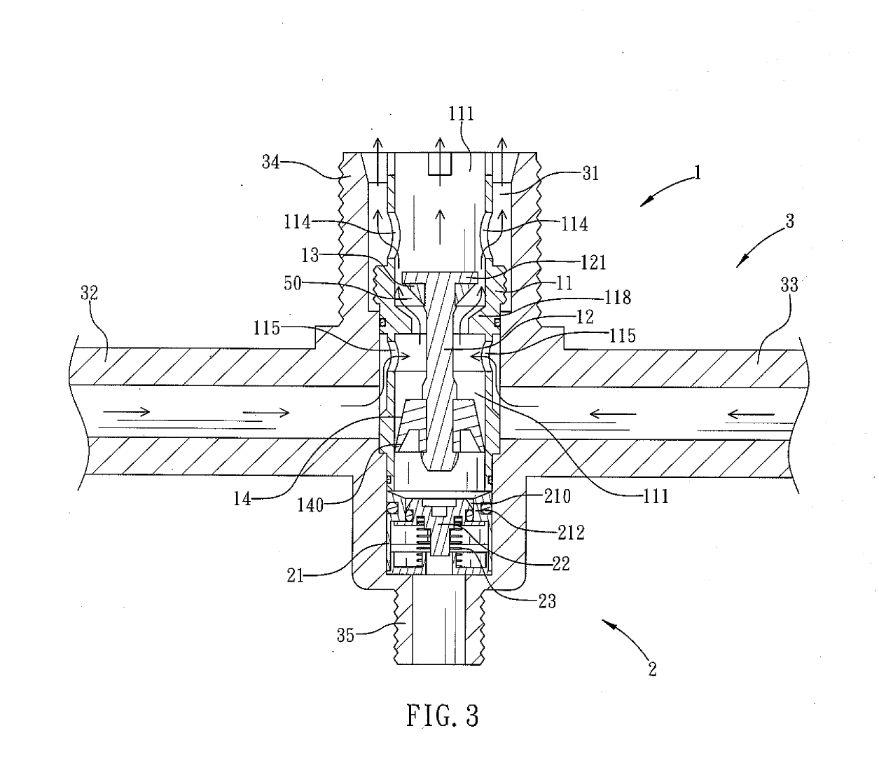

In operation, referring to FIGS. 2-4 with reference to FIG. 1, when the water outlet head 4 is closed, the water can be delivered to the spout. In such a manner, when water is delivered through the first inlet 32 and/or the second inlet 33 of the faucet body 3 into the receiving chamber 31 of the faucet body 3, the upper end 121 of the valve shaft 12 is pushed upward by the water pressure to form an annular gap 50 between the stopper 13 and the flange 118 of the valve body 11 so that the water from the first inlet 32 and/or the second inlet 33 of the faucet body 3 in turn flows through the two second connecting holes 115 of the valve body 11, the annular gap 50, the flow channel 111 of the valve body 11 and the two first connecting holes 114 of the valve body 11 into the upper outlet 34 of the faucet body 3 as shown in FIG. 3 and is delivered outward from the spout for use with a user. At this time, the sealing gasket 14 of the control valve 1 is located between the two second connecting holes 115 of the valve body 11 and the check valve 2 and has a tapered thin wall 140 pressing the peripheral wall of the flow channel 111 to isolate the flow channel 111 of the valve body 11 from the check valve 2 so as to prevent the water in the flow channel 111 of the valve body 11 from entering the check valve 2. In addition, the plug 22 of the check valve 2 is tightly inserted into the socket 212 of the valve housing 21 by the elastic force of the elastic member 23 to isolate the check valve 2 from the lower outlet 35 of the faucet body 3 so as to prevent the water in the flow channel 111 of the valve body 11 from passing through the check valve 2 into the lower outlet 35 of the faucet body 3.

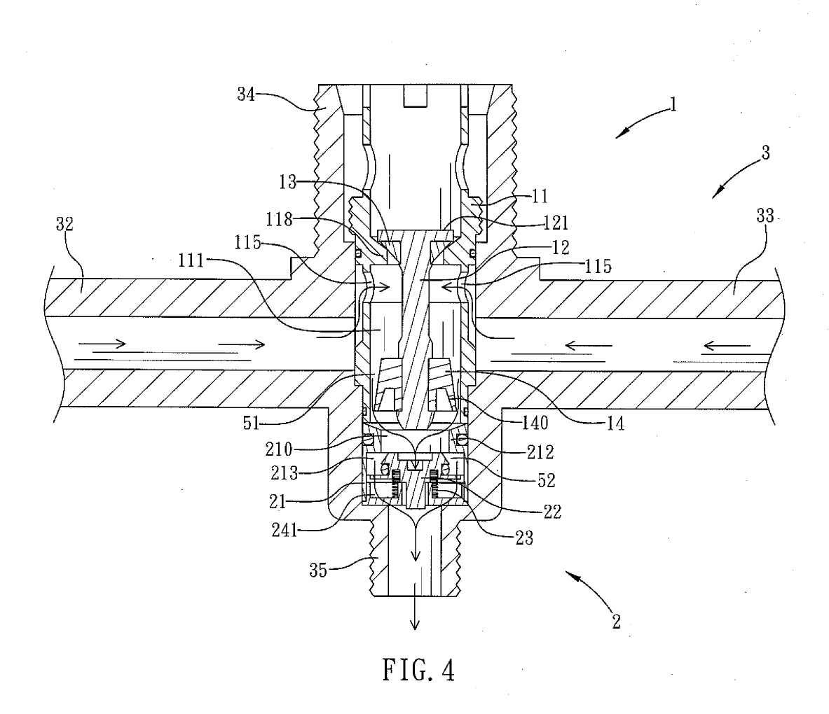

On the contrary, when the water outlet head 4 is opened by pressing the press button 41, the water can be delivered to the water outlet head 4. At this time, the stopper 13 presses and seals the flange 118 of the valve body 11 closely to prevent the water in the flow channel 111 of the valve body 11 from flowing into the upper outlet 34 of the faucet body 3. In such a manner, when the water is delivered through the first inlet 32 and/or the second inlet 33 of the faucet body 3 into the receiving chamber 31 of the faucet body 3, the tapered thin wall 140 of the sealing gasket 14 is pressed and contracted radially and inwardly by the water pressure to detach from the peripheral wall of the flow channel 111 so as to form a first gap 51 between the tapered thin wall 140 of the sealing gasket 14 and the peripheral wall of the flow channel 111, while the plug 22 of the check valve 2 is pushed by the water pressure to compress the elastic member 23 and to detach from the socket 212 of the valve housing 21 so as to form a second gap 52 between the plug 22 of the check valve 2 and the socket 212 of the valve housing 21 so that the water from the first inlet 32 and/or the second inlet 33 of the faucet body 3 in turn flows through the two second connecting holes 115 of the valve body 11, the flow channel 111 of the valve body 11, the first gap 51, the flow conduit 210 of the valve housing 21, the openings 213 of the valve housing 21 and the flow duct 241 of the base 24 into the lower outlet 35 of the faucet body 3 as shown in FIG. 4 and is then delivered through the hose 42 into the water outlet head 4. Thus, the water can be injected outward from the water outlet head 4 for use with the user. At this time, by provision of the openings 213 of the valve housing 21, the water can flow longitudinally through the flow conduit 210 of the valve housing 21 and can flow transversely through the openings 213 of the valve housing 21 so as to increase the water flow rate and to decrease the cost of fabrication.

After the water outlet head 4 is closed by releasing the press button 41, the faucet is returned to the original balance state as shown in FIG. 2. At this time, the plug 22 of the check valve 2 is pushed toward the socket 212 of the valve housing 21 by the restoring force of the elastic member 23 so that the plug 22 of the check valve 2 is tightly inserted into the socket 212 of the valve housing 21 to isolate the check valve 2 from the lower outlet 35 of the faucet body 3 so as to prevent the water in the lower outlet 35 of the faucet body 3 from passing through the check valve 2 into the flow channel 111 of the valve body 11. In addition, the tapered thin wall 140 of the sealing gasket 14 is expanded radially and outwardly by the elastic force of the sealing gasket 14 so that the tapered thin wall 140 of the sealing gasket 14 presses the peripheral wall of the flow channel 111 to isolate the flow channel 111 of the valve body 11 from the check valve 2 so as to prevent the water in the check valve 2 from entering the flow channel 111 of the valve body 11. In such a manner, even when the water outlet head 4 is placed in a drainage or sink and waste water flows through the water outlet head 4 into the lower outlet 35 of the faucet body 3, the plug 22 of the check valve 2 is tightly inserted into the socket 212 of the valve housing 21 to isolate the check valve 2 from the lower outlet 35 of the faucet body 3 so as to prevent the waste water in the lower outlet 35 of the faucet body 3 from passing through the check valve 2 into the flow channel 111 of the valve body 11, while the tapered thin wall 140 of the sealing gasket 14 presses the peripheral wall of the flow channel 111 to isolate the flow channel 111 of the valve body 11 from the check valve 2 so as to prevent the waste water in the check valve 2 from entering the flow channel 111 of the valve body 11.

Accordingly, the plug 22 of the check valve 2 is tightly inserted into the socket 212 of the valve housing 21 to isolate the check valve 2 from the lower outlet 35 of the faucet body 3, while the tapered thin wall 140 of the sealing gasket 14 presses the peripheral wall of the flow channel 111 to isolate the flow channel 111 of the valve body 11 from the check valve 2 so that the faucet has a double anti-reverse function to prevent the waste water from flowing backward into the faucet so as to protect the water source of the faucet. In addition, the water can flow transversely through the openings 213 of the valve housing 21 so as to increase the water flow rate and to decrease the cost of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A faucet, comprising:
a faucet body having an inner portion provided with a receiving chamber;
a control valve mounted in the receiving chamber of the faucet body; and
a check valve mounted in the receiving chamber of the faucet body and connected with the control valve;
wherein the faucet body is provided with a first inlet, a second inlet, an upper outlet and a lower outlet;
the control valve includes:
a valve body mounted in the receiving chamber of the faucet body and having an inner portion provided with a flow channel which has a peripheral wall provided with a flange;
a valve shaft movably mounted in the flow channel of the valve body;
a sealing gasket mounted on the valve shaft to move in concert with the valve shaft and abutting the peripheral wall of the flow channel to seal the flow channel of the valve body; and
a stopper mounted on the valve shaft to move in concert with the valve shaft and detachably abutting the flange of the valve body to seal the flow channel of the valve body;
the valve body of the control valve has a surface provided with two first connecting holes each connected between the flow channel of the valve body and the upper outlet of the faucet body and two second connecting holes each connected between the flow channel of the valve body and a respective one of the first inlet and the second inlet of the faucet body;
the check valve includes:
a valve housing mounted in the receiving chamber of the faucet body and having inner portion provided with a flow conduit which is connected to the flow channel of the valve body through the sealing gasket of the control valve and has a peripheral wall provided with a socket;
a base mounted on the valve housing and connected between the valve housing and the lower outlet of the faucet body;
a plug movably mounted in the flow conduit of the valve housing and detachably inserted into the socket of the valve housing to interrupt a connection between the flow conduit of the valve housing and the flow channel of the valve body; and
an elastic member biased between the base and the plug to push the plug toward the socket of the valve housing.

2. The faucet of claim 1, wherein the flange of the valve body is located between the two first connecting holes and the two second connecting holes.

3. The faucet of claim 1, wherein the sealing gasket of the control valve has a substantially inverted V-shaped cross-sectional profile.

4. The faucet of claim 1, wherein
the sealing gasket of the control valve has a tapered thin wall pressing the peripheral wall of the flow channel to isolate the flow channel of the valve body from the check valve;
the tapered thin wall of the sealing gasket is flexible and contractible radially and inwardly to detach from the peripheral wall of the flow channel to connect the flow channel of the valve body to the check valve.

5. The faucet of claim 1, wherein the valve housing of the check valve has a surface provided with a plurality of openings each connected to the flow conduit.

6. The faucet of claim 5, wherein the base of the check valve has an inner portion provided with a flow duct connected between the flow conduit of the valve housing and the lower outlet of the faucet body.

7. The faucet of claim 6, wherein
the base of the check valve is provided with a mounting tube located in the flow duct;
the mounting tube of the base has an inner portion provided with a mounting hole;
the plug of the check valve has a lower end provided with guide rod movably mounted in the mounting hole of the mounting tube.

8. The faucet of claim 7, wherein the base of the check valve has a bottom provided with a plurality of support ribs connected with the mounting tube to support the mounting tube.

9. The faucet of claim 7, wherein the elastic member of the check valve has an upper end mounted on the guide rod of the plug and a lower end mounted on the mounting tube of the base.

10. The faucet of claim 1, wherein the valve shaft of the control valve has an enlarged upper end provided with a first mounting portion for mounting the stopper and has an enlarged lower end provided with a second mounting portion for mounting the sealing gasket.

11. The faucet of claim 1, wherein
the flange of the valve body has a tapered shape;
the stopper of the control valve has a tapered shape.

12. The faucet of claim 1, wherein the valve body of the control valve has a peripheral wall provided with two retaining grooves to receive two O-rings which press a peripheral wall of the receiving chamber.

13. The faucet of claim 1, wherein the valve housing of the check valve has a peripheral wall provided with a retaining groove to receive an O-ring which presses the peripheral wall of the receiving chamber.

14. The faucet of claim 1, wherein the plug of the check valve has a peripheral wall provided with a retaining groove to receive an O-ring which presses a peripheral wall of the socket.

15. The faucet of claim 1, wherein
the first inlet, the second inlet, the upper outlet and the lower outlet of the faucet body are isolated from each other;
each of the first inlet, the second inlet, the upper outlet and the lower outlet of the faucet body is connected to the receiving chamber of the faucet body;
the receiving chamber of the faucet body is connected between the first inlet, the second inlet, the upper outlet and the lower outlet of the faucet body.

16. The faucet of claim 1, wherein
the control valve is located between the upper outlet of the faucet body and the check valve;
the check valve is located between the control valve and the lower outlet of the faucet body.

17. The faucet of claim 1, wherein
the stopper of the control valve is located between the flange and the two first connecting holes of the valve body;
the sealing gasket of the control valve is located between the two second connecting holes of the valve body and the check valve.

18. The faucet of claim 1, wherein the valve housing of the check valve has an upper end juxtaposed to a lower end of the valve body and a lower end mounted on the base.

19. The faucet of claim 1, wherein the plug of the check valve is limited between the socket of the valve housing and the base.
